(19) United States
(12) Patent Application Publication
(10) Pub. No.: US 2014/0080080 A1
(43) Pub. Date: Mar. 20, 2014

(54) Annealed WVT Membranes to Impart Durability and Performance

(71) Applicants: Annette M. Brenner, Honeoye Falls, NY (US); Shawn M. Clapham, Canadaigua, NY (US); Lijun Zou, Rochester, NY (US); Timothy J. Fuller, Pittsford, NY (US); Craig S. Gittleman, Rochester, NY (US)

(72) Inventors: Annette M. Brenner, Honeoye Falls, NY (US); Shawn M. Clapham, Canadaigua, NY (US); Lijun Zou, Rochester, NY (US); Timothy J. Fuller, Pittsford, NY (US); Craig S. Gittleman, Rochester, NY (US)

(73) Assignee: GM GLOBAL TECHNOLOGY OPERATIONS LLC, Detroit, MI (US)

(21) Appl. No.: 13/617,482

(22) Filed: Sep. 14, 2012

(51) Int. Cl. C08J 5/22

(52) U.S. Cl. 432/9; 521/27

(57) ABSTRACT

A method for improving the chemical stability of a vapor transfer membrane includes providing a vapor transfer membrane including an ionomer layer having protogenic groups and then annealing the vapor transfer membrane at a temperature greater than about 100° C. Advantageously, the performance and durability of WVT membranes are markedly improved by thermally annealing the membranes.

### TECHNICAL FIELD

The invention relates to a fuel cell and, more particularly, to humidification of fuel cells using annealed polymer layers to improve mechanical and chemical properties.

### BACKGROUND

Fuel cells are used as an electrical power source in many applications. In particular, fuel cells are proposed for use in automobiles to replace internal combustion engines. A commonly used fuel cell design uses a solid polymer electrolyte (“SPE”) membrane or proton exchange membrane (“PEM”) to provide ion transport between the anode and cathode.

In proton exchange membrane type fuel cells, hydrogen is supplied to the anode as fuel and oxygen is supplied to the cathode as the oxidant. The oxygen can either be in pure form (O₂) or air (a mixture of O₂ and N₂). PEM fuel cells typically have a membrane electrode assembly (“MEA”) in which a solid polymer membrane has an anode catalyst on one face, and a cathode catalyst on the opposite face. The anode and cathode layers of a typical PEM fuel cell are formed of porous conductive materials, such as woven graphite, graphitized sheets, or carbon paper to enable the fuel to disperse over the surface of the membrane facing the fuel supply electrode. Each electrode has finely divided catalyst particles (for example, platinum particles), supported on carbon particles, to promote oxidation of hydrogen at the anode and reduction of oxygen at the cathode. Protons flow from the anode through the ionically conductive polymer membrane to the cathode where they combine with oxygen to form water, which is discharged from the cell. The MEA is sandwiched between a pair of porous gas diffusion layers (“GDL”), which in turn are sandwiched between a pair of non-porous, electrically conductive elements or plates. The plates function as current collectors for the anode and the cathode, and contain appropriate channels and openings formed therein for distributing the fuel cell's gaseous reactants over the surface of respective anode and cathode catalysts. In order to produce electricity efficiently, the polymer electrolyte membrane of a PEM fuel cell must be thin, chemically stable, proton transmissive, non-electrically conductive and gas impermeable. In typical applications, fuel cells are provided in arrays of many individual fuel cells in stacks in order to provide high levels of electrical power.

The internal membranes used in fuel cells are typically maintained in a moist condition.

This helps avoid damage to or a shortened life of the membranes, as well as to maintain the desired efficiency of operation. For example, lower water content of the membrane leads to a higher proton conduction resistance, thus resulting in a higher ohmic voltage loss. The humidification of the feed gases, in particular the cathode inlet, is desirable in order to maintain sufficient water content in the membrane, especially in the inlet region. Humidification in a fuel cell is discussed in commonly owned U.S. patent application Ser. No. 10/797,671 to Goebel et al.; commonly owned U.S. patent application Ser. No. 10/912,298 to Sennoun et al.; and commonly owned U.S. patent application Ser. No. 11/087,911 to Forte, each of which is hereby incorporated herein by reference in its entirety.

To maintain a desired moisture level, an air humidifier is frequently used to humidify the air stream used in the fuel cell. The air humidifier normally consists of a round or box type air humidification module that is installed into a housing of the air humidifier. Examples of this type of air humidifier are shown and described in U.S. patent application Ser. No. 10/516,483 to Tanihara et al., and U.S. Pat. No. 6,471,195, each of which is hereby incorporated herein by reference in its entirety.

Membrane humidifiers have also been utilized to fulfill fuel cell humidification requirements. For the automotive fuel cell humidification application, such a membrane humidifier needs to be compact, exhibit low pressure drop, and have high performance characteristics.

Designing a membrane humidifier requires a balancing of mass transport resistance and pressure drop. To transport water from wet side to dry side through a membrane, water molecules must overcome some combination of the following resistances: convectional mass transport resistance in the wet and dry flow channels; diffusion transport resistance through the membrane; and diffusion transport resistance through the membrane support material. Compact and high performance membrane humidifiers typically require membrane materials with a high water transport rate (i.e. GPU in the range of 10,000-16,000). GPU or gas permeation unit is a partial pressure normalized flux where 1 GPU=10⁻⁶ cm³ (STP)/(cm² sec cm Hg). As a result, minimizing the transport resistance in the wet and dry flow channels and the membrane support material becomes a focus of design.

Although the prior art water vapor transfer membranes work reasonably well, the commercially available perfluorosulfonic acid ionomer membranes dissolve in water. Moreover, these membranes show appreciable performance degradation during use that is not related to chemical contamination by salts.

Accordingly, there is a need for improved materials and methodologies for humidifying fuel cells.

### SUMMARY OF THE INVENTION

The present invention solves one or more problems of the prior art by providing in at least one embodiment a method for improving the mechanical stability and water insolubility of a vapor transfer membrane. The method includes providing a vapor transfer membrane including an ionomer layer having protogenic groups and then annealing the vapor transfer membrane at a temperature greater than about 100° C. Advantageously, the performance and durability of WVT membranes are markedly improved by thermally annealing the membranes.

In another embodiment, the annealed vapor transfer membrane is incorporated into a vapor transfer membrane system that may be used in conjunction with a fuel cell stack.

### BRIEF DESCRIPTION OF THE DRAWINGS

Exemplary embodiments of the present invention will become more fully understood from the detailed description and the accompanying drawings, wherein:

FIG. 1 provides a schematic of a fuel cell system including a membrane humidifier assembly for humidifying a cathode inlet airflow to a fuel cell stack;

FIG. 2 provides a schematic of a fuel cell system incorporating a membrane humidifier;

FIG. 3 provides a schematic cross section of a composite vapor transfer membrane;

FIG. 4 provides a schematic cross section of a composite vapor transfer membrane;

FIG. 5 provides the water permeance performance of annealed and unannealed water vapor transport (WVT) membranes;

FIG. 6 provides the water permeance performance and leak rate of annealed and unannealed membranes before and after 10 days in deionized water (DI) at 90° C.; and

FIG. 7 provides the water vapor permeance performance of an annealed membrane with time.

### DETAILED DESCRIPTION OF THE PREFERRED EMBODIMENT(S)

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the term “polymer” includes “oligomer,” “copolymer,” “terpolymer,” and the like; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

Throughout this application, where publications are referenced, the disclosures of these publications in their entireties are hereby incorporated by reference into this application to more fully describe the state of the art to which this invention pertains.

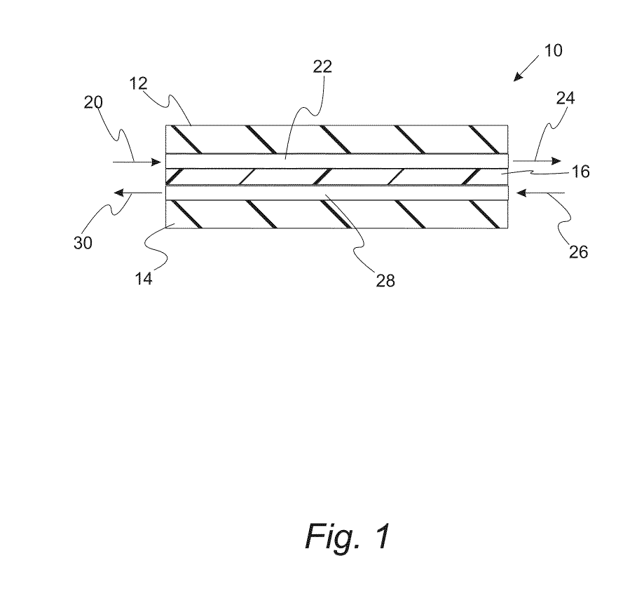

With reference to FIG. 1, a schematic cross section of a membrane humidifier incorporating the membrane set forth above is provided. The membrane humidifier of this embodiment may be used in any application in which it is desirable to transfer water from a wet gas to a dry gas. Membrane humidifier 10 includes first flow field plate 12 adapted to facilitate flow of a first gas to membrane humidifier 10. Membrane humidifier 10 also includes second flow field plate 14 adapted to facilitate flow of a second gas thereto. Polymeric vapor transfer membrane 16 is disposed between the first flow field plate 12 and second flow field plate 14. Polymeric vapor transfer membrane 16 includes an annealed ionomer (i.e., polymer) layer having protogenic groups as set forth below. In a refinement, vapor transfer membrane 16 is annealed at a temperature greater than 100° C. In another refinement, vapor transfer membrane 16 is annealed at a temperature from about 100° C. to about 250° C. In another refinement, vapor transfer membrane 16 is annealed at a temperature from about 120° C. to about 200° C. In another refinement, vapor transfer membrane 16 is annealed at a temperature from about 135° C. to about 150° C. In still another refinement, the transfer membrane is annealed for 0.1 to 24 hours. In a particular refinement, the transfer membrane is annealed for 1 to 24 hours at 140° C. or 15 minutes at 200° C. In a variation, first flow field plate 12 is a wet plate and second flow field plate 14 is a dry plate. Wet gas 20 (e.g., air) is introduced into channel 22 of flow field plate 12. The output of wet gas 20 is designated by item number 24. Dry gas 26 (e.g., air) is introduced into channel 28 of flow field plate 14 where it is humidified. The humidified gas is designated by item number 30.

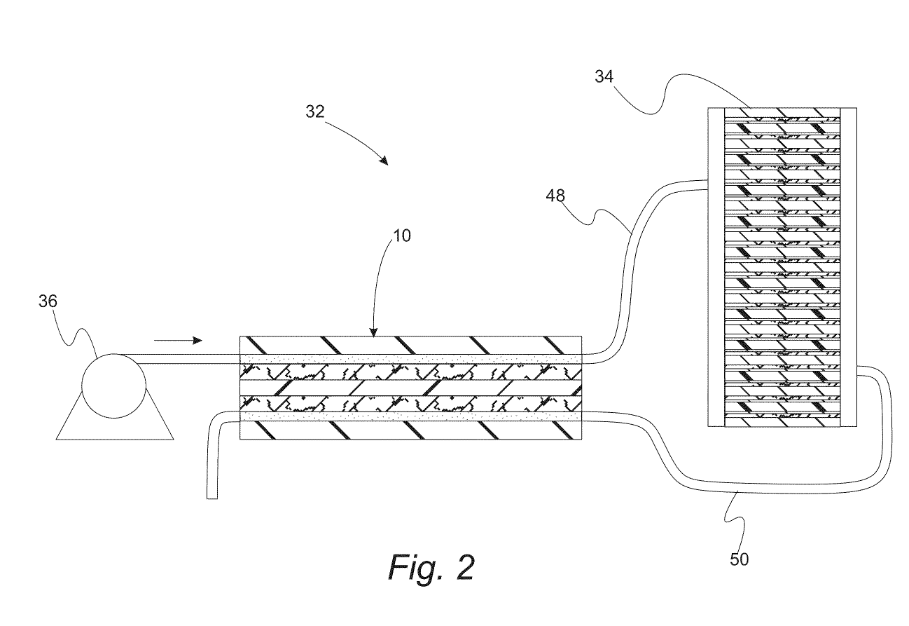

With reference to FIG. 2, a schematic illustration of a fuel cell system incorporating a membrane humidifier 10 is provided. Fuel cell system 32 includes fuel cell stack 34. Compressor l provides a flow of air to the cathode side of the stack 34 on a cathode input line 48. The flow of air from the compressor 36 is sent through membrane humidifier assembly 10 to be humidified. A cathode exhaust gas is output from the stack 34 on a cathode output line 50. The cathode exhaust gas includes a considerable amount of water vapor and/or liquid water as a by-product of the electrochemical process in the fuel cell stack 34. As is well understood in the art, the cathode exhaust gas can be sent to membrane humidifier 10 to provide the humidification for the cathode inlet air on the line 48.

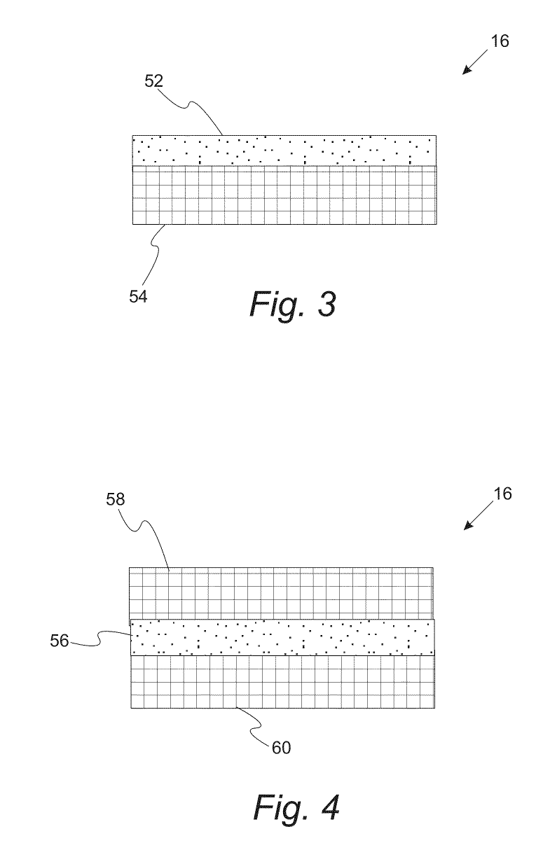

With reference to FIGS. 3 and 4, variations of the vapor transfer membrane are provided. In addition to be a single ionomeric layer, FIG. 3 provides a variation in which the vapor transfer membrane is a composite. In this variation, vapor transfer membrane 16 includes ionomer layer 52 disposed over microporous layer 54. Ionomer layer 52 typically includes protogenic groups. In a refinement, a portion of ionomer layer 52 is imbibed into microporous layer 54. FIG. 4 provides another variation in which the vapor transfer layer is a composite. In this variation, vapor transfer membrane 16 includes ionomer layer 56 sandwiched between microporous layer 58 and microporous layer 60. Ionomer layer 56 includes protogenic groups. An example of a microporous layer is an expanded polytetrafluoroethylene (PTFE) layer. In a refinement, a portion of ionomer layer 56 is imbibed into microporous layer 54, 58, or 60. Commercially available vapor transfer membranes include the GORE™ M311.05 membrane, a PFSA WVT membrane.

As set forth above, the vapor transfer membranes include an ionomer layer that has protogenic groups. Examples of protogenic groups include, but are not limited to, —SO₂X, —PO₃H₂, —COX, and the like where X is an —OH, a halogen, or a C₁₋₆ ester. In a variation, the ionomer having protogenic groups is a perfluorosulfonic acid polymer (PFSA). In a refinement, such PFSAs are a copolymer containing a polymerization unit based on a perfluorovinyl compound represented by:

CF₂═CF—(OCF₂CFX¹)ₘ—Oᵣ—(CF₂)_{q}—SO₃H

where m represents an integer of from 0 to 3, q represents an integer of from 1 to 12, r represents 0 or 1, and X¹ represents a fluorine atom or a trifluoromethyl group and a polymerization unit based on tetrafluoroethylene.

In another variation, the polymer having protogenic groups is a perfluorocyclobutyl-containing (PFCB) ionomer. Suitable PFCB ionomers are disclosed in U.S. Pat. Pub. No. 2007/0099054, U.S. Pat. Nos. 7,897,691 issued Mar. 1, 2011; 7,897,692 issued Mar. 1, 2011; 7,888,433 issued Feb. 15, 2011, 7,897,693 issued Mar. 1, 2011; and 8,053,530 issued Nov. 8, 2011, the entire disclosures of which are hereby incorporated by reference. Examples of perfluorocyclobutyl moieties are:

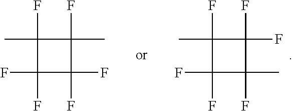

In a variation, the ion-conducting ionomer having perfluorocyclobutyl moieties includes a polymer segment comprising polymer segment 1:

E₀—P₁—Q₁—P₂ 1

wherein:
E₀ is a moiety, and in particular, a hydrocarbon-containing moiety, that has a protogenic group such as —SO₂X, —PO₃H₂, —COX, and the like;
P₁, P₂ are each independently absent, —O—, —SO—, —SO—, —CO—, —SO₂—, —NH—, NR₂—, or —R₃—;
R₂ is C₁₋₂₅ alkyl, C₆₋₂₅ aryl or C₆₋₂₅ arylene;
R₃ is C₁₋₂₅ alkylene, C₂₋₂₅ perfluoroalkylene, C₂₋₂₅ perfluoroalkyl ether, C₂₋₂₅ alkylether, or C₆₋₂₅ arylene;
X is an —OH, a halogen, an ester, or

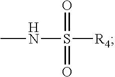

R₄ is trifluoromethyl, C₁₋₂₅ alkyl, C₂₋₂₅ perfluoroalkylene, C₆₋₂₅ aryl, or E₁; and
Q₁ is a fluorinated cyclobutyl moiety.

The following examples illustrate the various embodiments of the present invention. Those skilled in the art will recognize many variations that are within the spirit of the present invention and scope of the claims.

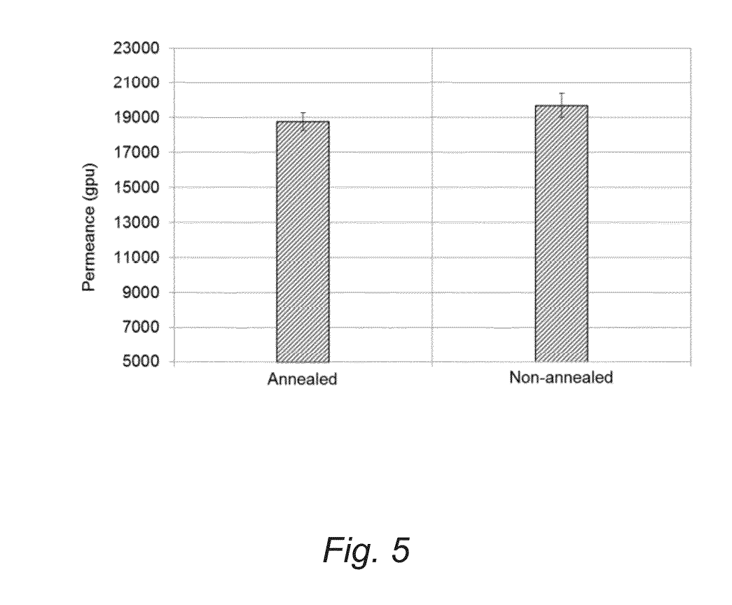

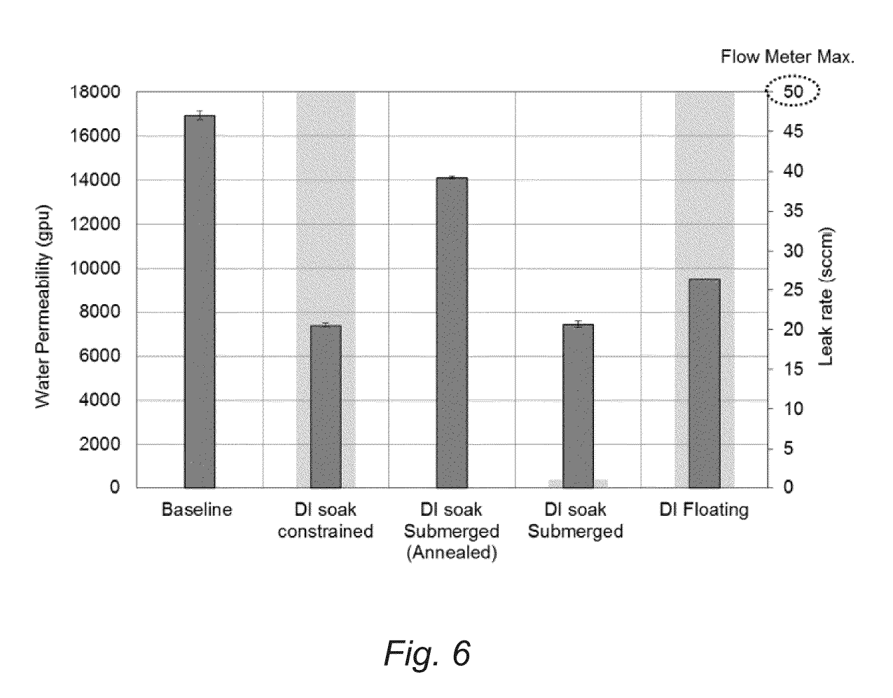

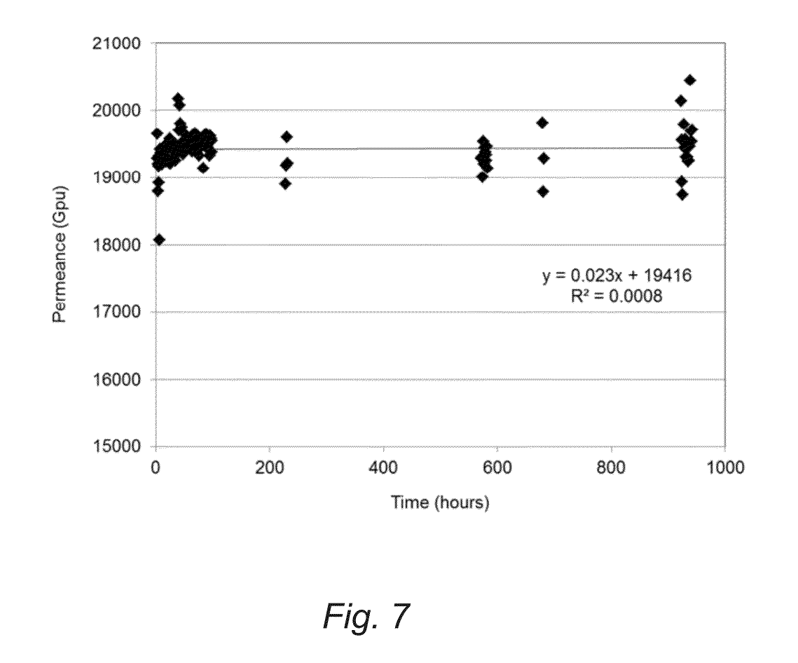

A GORE™ M311.05 membrane was thermally annealed at 140° C. for about 16 hours. FIG. 5 shows that there is no performance loss of the membrane after annealing from the beginning of life properties. FIG. 6 shows the annealed membrane has only 16.7% performance drop and no crossover leak. However, the non-annealed samples have greater than 45% performance loss and several of them failed by crossover leak. FIG. 7 shows the water vapor permeance decay rate of annealed WVT membrane is −0.19 gpu/hr and, by extrapolation, it is greater than 3 times lower than the current durability target of less than −0.71 gpu/hr based on the durability requirement of less than 20% performance degradation at 5500 hours.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of improving the chemical stability of a vapor transfer membrane, the method comprising:
providing a vapor transfer membrane including an ionomer layer having protogenic groups; and
annealing the vapor transfer membrane at a temperature greater than about 100° C.

2. The method of claim 1 wherein the transfer membrane is annealed in air.

3. The method of claim 1 wherein the transfer membrane is annealed in an inert gas.

4. The method of claim 1 wherein the transfer membrane is annealed for 1 to 24 hours at 140° C. or 15 minutes at 200° C.

5. The method of claim 1 wherein the transfer membrane is annealed at a temperature from 100° C. to 250° C.

6. The method of claim 1 wherein the transfer membrane is annealed at a temperature from 135° C. to 150° C.

7. The method of claim 1 wherein the transfer membrane further includes a first microporous layer.

8. The method of claim 7 wherein the transfer membrane further includes a second microporous layer with the ionomer layer disposed between the first microporous layer and the second microporous layer.

9. The method of claim 1 wherein the ionomer layer comprises a perfluorosulfonic acid polymer.

10. The method of claim 9 wherein the perfluorosulfonic acid polymer is a copolymer containing a polymerization unit based on a perfluorovinyl compound represented by:
CF₂═CF—(OCF₂CFX¹)ₘ—Oᵣ—(CF₂)_{q}—SO₃H
where m represents an integer of from 0 to 3, q represents an integer of from 1 to 12, r represents 0 or 1, and X¹ represents a fluorine atom or a trifluoromethyl group and a polymerization unit based on tetrafluoroethylene.

11. The method of claim 1 wherein the ionomer layer comprises a perfluorocyclobutyl-containing polymer.

12. A method comprising comprising:
providing a vapor transfer membrane including an ionomer layer having protogenic groups;
annealing the vapor transfer membrane at a temperature from about 100° C. to about 250° C. to form an annealled vapor transfer membrane; and
incorporating the annealed vapor transfer membrane in a vapor transfer system.

13. The method of claim 12 wherein the transfer membrane is annealed in air.

14. The method of claim 12 wherein the transfer membrane is annealed in an inert gas.

15. The method of claim 12 wherein the transfer membrane is annealed at a temperature from 135° C. to 150° C.

16. The method of claim 12 wherein the transfer membrane further includes a first microporous layer and a second microporous layer with the ionomer layer disposed between the first microporous layer and the second microporous layer.

17. The method of claim 12 wherein the ionomer layer comprises a perfluorosulfonic acid polymer.

18. The method of claim 17 wherein the perfluorosulfonic acid polymer is a copolymer containing a polymerization unit based on a perfluorovinyl compound represented by:
CF₂═CF—(OCF₂CFX¹)ₘ—Oᵣ—(CF₂)_{q}—SO₃H
where m represents an integer of from 0 to 3, q represents an integer of from 1 to 12, r represents 0 or 1, and X¹ represents a fluorine atom or a trifluoromethyl group and a polymerization unit based on tetrafluoroethylene.

19. The method of claim 12 wherein the ionomer layer comprises a perfluorocyclobutyl-containing polymer.
